(19) United States
(12) Patent Application Publication
(10) Pub. No.: US 2025/0119089 A1
(43) Pub. Date: Apr. 10, 2025

(54) Inverter for driving an electric machine and method of operating the inverter

(71) Applicant: SEG Automotive Germany GmbH, Stuttgart (DE)

(72) Inventors: Nima SAADAT, Stuttgart (DE); Murugaperumal DEVARAJA, Stuttgart (DE); Othman Abdulhadi TAHA, Stuttgart (DE); Vivek Ratilal TAILOR, Stuttgart (DE)

(21) Appl. No.: 18/902,464

(22) Filed: Sep. 30, 2024

(30) Foreign Application Priority Data
Oct. 5, 2023 (DE) 102023127209.8

(51) Int. Cl. H02P 27/06; H02H 7/08

(52) U.S. Cl. CPC H02P 27/06; H02H 7/0833

(57) ABSTRACT

An inverter for driving an electrical machine has a power converter circuit, a safety control device and a power supply circuit for supplying the power converter circuit and the safety control device. The safety control device is configured to switch the power converter circuit to a safe state when a shutdown situation is present. The power supply circuit has a high-voltage branch, a first low-voltage branch and a second low-voltage branch, the high-voltage branch being electrically connected to the first low-voltage branch via an operating DC-DC converter, wherein neither the high-voltage branch nor the first low-voltage branch are electrically connected to the second low-voltage branch, wherein the power converter circuit and the safety control device are supplied with energy from the first low-voltage branch and the second low-voltage branch.

### CROSS-REFERENCE TO RELATED APPLICATIONS

This application claims priority to German Patent Application No. 102023127209.8 filed Oct. 5, 2023 which is hereby incorporated by reference.

### TECHNICAL FIELD

The present disclosure relates to an inverter for controlling an electrical machine and a method for operating the inverter.

### BACKGROUND

A power supply circuit of an inverter or in an inverter is also referred to as a PDN or PDTN (power distribution network or power distribution tree network) in modern vehicle applications with an electric drive. The task of this power distribution network is, among other things, to distribute power to the various components or consumers of the inverter, such as sensors, communication circuits (e.g. CAN, LIN transceivers) and in particular the gate driver circuits for high-side (HS) and low-side (LS) switches, and functional safety circuits or MCU (microcontroller unit), etc. In this sense, the inverter is a device which internally has the power supply circuit and components supplied by it, including switches, e.g. in the form of half bridges, and terminals for connecting external power sources and an electrical machine.

Nowadays, due to functional safety requirements, there can be two main power sources for the PDN. A common power source in electric vehicles (EV) is low-voltage batteries (e.g. 12 V), also known as the KL.30 network or low-voltage branch. A second source can be a high-voltage DC battery or the high-voltage DC bus (high-voltage branch) with a nominal voltage of 400 V to more than 1,000 V, for example. Such high-voltage, HV, networks can be used in particular as a power supply for an electric traction drive, such as a permanent magnet synchronous motor (PMSM), which is connected to the high-voltage branch via the inverter.

In the event of an incident or emergency shutdown, the inverter should enter a predefined safe state. To prevent the DC link capacitors from being charged by the electrical machine (especially when using PMSM), the active short circuit (ASC) technique is usually used, whereby all low-side (LS) switches or all high-side (HS) switches are closed, stopping the transfer of energy from the electrical machine to the DC link.

The disclosure aims to improve this concept in order to reliably achieve a safe state even in the event of problems with the power supply to the components involved.

### SUMMARY

According to the disclosure, an inverter for controlling an electrical machine, in particular in a vehicle, and a method for operating the inverter with the features of the independent patent claims are proposed. Advantageous embodiments are the subject of the dependent claims and the following description. It should be emphasized that the features and advantages described below apply equally to the inverter and the method for operating the inverter.

The disclosure describes a way of improving the power or energy supply in an inverter in such a way that a safe state of the inverter or the electrical machine in the vehicle is reliably achieved even in the event of a fault.

In detail, the inverter has a power converter circuit, a safety control device and a power supply circuit for supplying the power converter circuit and the safety control device.

As is known, an inverter circuit or a power converter circuit is used to connect the AC voltage terminals of the electrical machine to DC voltage terminals or to generate an AC voltage for the electrical machine from a DC voltage, in particular from the high-voltage network or high-voltage branch. For this purpose, the power converter circuit has a number of semiconductor switches, each of which can be opened (non-conductive) and closed (conductive) in accordance with a control signal. The semiconductor switches can comprise MOSFETs and IGBTs, for example gallium nitride (GaN) or silicon carbide (SiC) FETs.

The power supply circuit in the inverter has at least three different branches, namely a high-voltage branch, a first low-voltage branch and a second low-voltage branch. The high-voltage branch is configured to be connected to a high-voltage network (in particular in the vehicle), and the first low-voltage branch is supplied from the high-voltage branch via an operating DC-DC converter, with a nominal voltage level of the high-voltage network being higher than a nominal voltage level of the low-voltage network. The second low-voltage branch is neither electrically connected to the high-voltage branch nor to the first low-voltage branch and is configured to be connected to a low-voltage network (in particular in the vehicle). The high-voltage branch and the second low-voltage branch have corresponding terminals for connecting to the high-voltage network or low-voltage network. In particular, these terminals are led out of a housing of the inverter.

The nominal voltage level of the high-voltage network (hereinafter also referred to as the high-voltage level) can, for example, be significantly higher than a permissible touch voltage of 60 V, e.g. up to several hundred volts. For example, high-voltage levels of 400 V or 800 V are often used in current electric vehicles. The nominal voltage level of the low-voltage network and the second low-voltage branch can in particular be essentially the same, i.e. deviate from each other by no more than a threshold value of e.g. 5 V, and can for example correspond to standard vehicle low voltages of e.g. 12 V or 24 V.

The power converter circuit (i.e. its components) and the safety control device are supplied with energy or current from the first low-voltage branch and the second low-voltage branch. This increases functional safety.

In one embodiment, the power converter circuit can have a number of high-side (HS) semiconductor switches and a number of low-side (LS) semiconductor switches and a gate driver circuit for the HS semiconductor switches (hereinafter referred to as HS gate driver circuit) and a gate driver circuit for the LS semiconductor switches (hereinafter referred to as LS gate driver circuit). A gate driver circuit is used to apply a drive signal to a control terminal of a semiconductor switch (e.g. gate terminal of MOSFET).

In one embodiment, a first gate driver circuit of the HS gate driver circuit and the LS gate driver circuit is supplied with energy from the first low-voltage branch, and a second gate driver circuit of the HS gate driver circuit and the LS gate driver circuit is supplied with energy from the second low-voltage branch. This means, for example, that a safe state can still be brought about by an active short circuit even in the event of a fault or failure of one of the first low-voltage branch or the second low-voltage branch.

In at least one embodiment, the HS and the LS gate driver circuit can each be supplied with voltage by at least one bias supply circuit (i.e. HS and LS), wherein a first bias supply circuit of the HS and the LS bias supply circuit is supplied with energy from the first low-voltage branch, and a second bias supply circuit of the HS and the LS bias supply circuit is supplied with energy from the second low-voltage branch.

The safety control device is configured to switch the converter circuit to a safe state when a shutdown situation occurs. In particular, this can be the creation of an active short circuit (determining the type of active short circuit (HS/LS) and closing all HS switches or closing all LS switches). The presence of a shutdown situation is determined in particular when a fault occurs or is detected.

By means of the inverter of the disclosure, safety-relevant loads can be supplied independently of each other from both the first low-voltage branch and the second low-voltage branch and can therefore also be supplied with power or energy in the event of a problem with the high-voltage branch or the operating DC-DC converter. In the event of a defect in the operating DC-DC converter, the second low-voltage branch continues to be supplied. Since the second low-voltage branch is supplied from the low-voltage network, which in principle already has a suitable voltage, it can be designed very simply in terms of electrical engineering and safety. Nevertheless, a DC-DC converter can be used to convert the low voltage from e.g. 12 V (nominal voltage) to a slightly higher value of e.g. 15 V to 20 V, which is more suitable for supplying electronic components etc.

The method according to the disclosure for operating an inverter according to the disclosure comprises bringing the power converter circuit into a safe state when a switch-off situation is present.

The disclosure significantly increases the functional safety of inverters, which has particular advantages in terms of personal safety, especially in cases with a high-voltage branch. The disclosure requires very few regular components for implementation and is therefore very simple and inexpensive to realize.

In one embodiment, the operating DC-DC converter can optionally be a non-isolating DC-DC converter, such as a buck converter, synchronous converter, SEPIC converter (single ended primary inductance converter), Ćuk converter, zeta converter, etc. With non-isolating DC-DC converters, there is no electrical isolation between the input network and the output network. These are usually inexpensive to use.

In one embodiment, the operating DC-DC converter can optionally also be an insulating DC-DC converter, such as a fly-back converter, forward converter, push-pull converter, etc. With insulating DC-DC converters, there is galvanic isolation between the input network and the output network, which is usually achieved by means of a transformer. These have increased safety, but are more complex in terms of weight, installation space and costs. In the high-voltage range (>60 V), the use of an insulating DC-DC converter is advantageous or even mandatory for safety reasons.

In one embodiment, the operating DC-DC converter can be disconnected from the first low-voltage branch by means of a first safety disconnector and/or can be disconnected from the high-voltage branch by means of a high-voltage disconnector. This means that in the event of a fault in the first low-voltage branch, damage to the operating DC-DC converter or the high-voltage branch can be avoided, or in the event of a fault in the operating DC-DC converter, damage to the first low-voltage branch or the high-voltage branch can be avoided.

In one embodiment, the first gate driver circuit can be disconnected from the first low-voltage branch by means of a second safety disconnector. This means that in the event of a fault in the first gate driver circuit, impairment of the first low-voltage branch can be avoided and vice versa.

In one embodiment, the second low-voltage branch can be disconnected from the low-voltage network (on the supply side) by means of a third safety disconnector. This means that in the event of a fault in the low-voltage network, damage to the second low-voltage branch can be avoided and vice versa.

In fault-free operation, each of the safety disconnectors and high-voltage disconnectors, if present, can be closed or conductive so that all branches are connected and functional as described above. Each of the safety disconnectors and high-voltage disconnectors, if present, may optionally be arranged to open, i.e. to switch to a non-conductive state, in response to an external opening signal and/or on detection of a fault such as an excess of a current value of a current flowing through it.

Each of the safety disconnectors and high-voltage disconnectors, if present, can optionally comprise one or more semiconductor switches or mechanical switches (relays). The high-voltage disconnectors in particular can also be passively openable and designed in the form of fuses.

In one embodiment, the safety control device is configured to detect the presence of a shutdown situation if at least one of the first, second and third safety disconnectors, if present, is in a non-conductive state. This allows a shutdown situation to be reliably detected.

In one embodiment, the safety control device is configured to detect the presence of a shutdown situation if the operating DC-DC converter is faulty. This allows a safe state to be reliably established in such fault situations.

In one embodiment, the safety control device and/or the power converter circuit each have at least two power supply circuits, wherein a first of the at least two power supply circuits is supplied or can be supplied with power from the first low-voltage branch, and a second of the at least two power supply circuits is supplied or can be supplied with power from the second low-voltage branch. Such a solution with two (in particular redundant) power supply circuits can avoid a connection point between the first low-voltage branch and the second low-voltage branch. A power supply circuit is used to generate the required voltages in the supplied component from an input voltage, in this case at the low-voltage level. Typically, a power supply circuit itself can have DC-DC converters, low dropout regulators (LDO), etc.

Further advantages and embodiments of the disclosure are shown in the description and the accompanying drawing.

The disclosure is illustrated schematically in the drawing by means of embodiment examples and is described below with reference to the drawing.

### BRIEF DESCRIPTION OF THE DRAWINGS

FIG. 1 schematically shows an inverter, in embodiments.

FIG. 2 schematically shows a further inverter, in embodiments.

FIG. 3 schematically shows a further inverter, in embodiments.

FIG. 4 schematically shows a power converter circuit as it can be used in an inverter, in embodiments.

FIG. 5 schematically shows a further power converter circuit, as can be used in an inverter, in embodiments.

FIG. 6 schematically shows a further embodiment of an inverter, in embodiments.

FIG. 7 schematically shows a further power converter circuit, as can be used in an inverter, in embodiments.

FIG. 8 schematically shows a safety disconnector, as can be used in an inverter, in embodiments.

### DETAILED DESCRIPTION

In the following, embodiments of the disclosure are described in a coherent and comprehensive manner with reference to the figures. In order to reduce the complexity of the figures, not all connections and signal flows are shown. Signal flows shown in the figures are used to request the safe state (safe-to-state requirements or ASC requirements for the HS and LS gate drivers). Return lines or ground or negative lines are also not shown in all events.

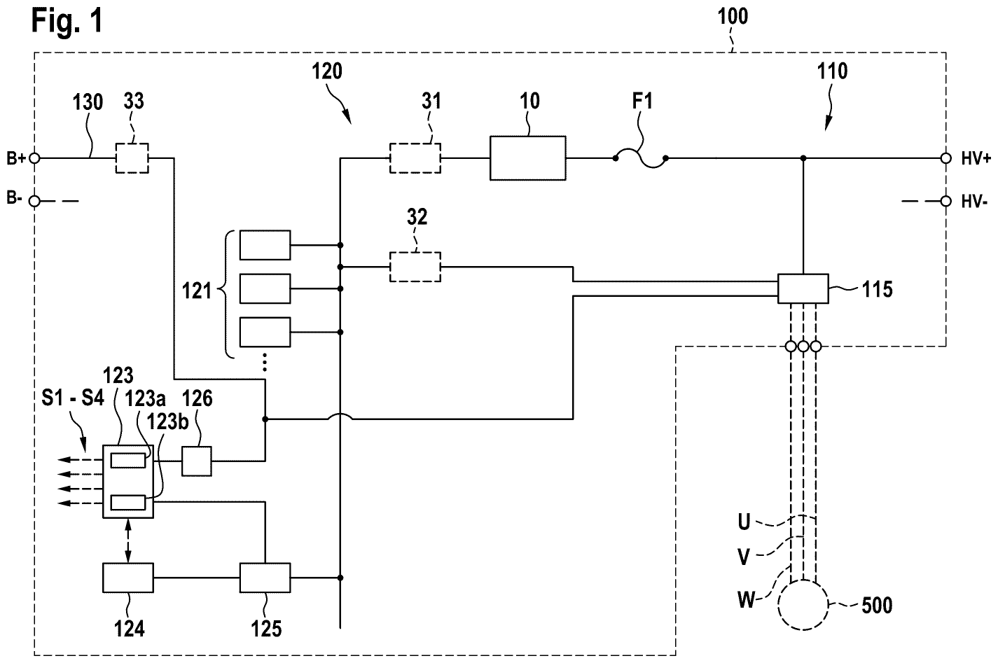

FIGS. 1, 2, 3 and 6 schematically show slightly different embodiments of an inverter 100 according to the disclosure. In vehicles, an inverter is usually a component or device that controls the electrical machine. In particular, the inverter can implement torque and speed control and, in doing so, convert the DC voltage on the vehicle electrical network side into AC voltage on the engine side and-in the case of recuperation-conversely convert the AC voltage on the engine side into DC voltage on the vehicle electrical network side and feed it into the vehicle electrical network.

The inverter 100 has a power supply circuit with a high-voltage branch 110 with high-voltage terminals HV+, HV− (DC voltage) for connecting a high-voltage network with a high-voltage level, a second low-voltage branch 130 with low-voltage terminals B+, B− (DC voltage) for connecting a low-voltage network (so-called terminal 30 network) with a low-voltage level, and a first low-voltage branch 120 with the low-voltage level. The high-voltage level is, for example, in the range from 40 V to 1,000 V. The low-voltage level can be 12 V or 24 V, for example.

The high-voltage branch 110 is connected to the first low-voltage branch 120 via an operating DC-DC converter 10, with the first low-voltage branch 120 being fed or supplied from the high-voltage branch 110.

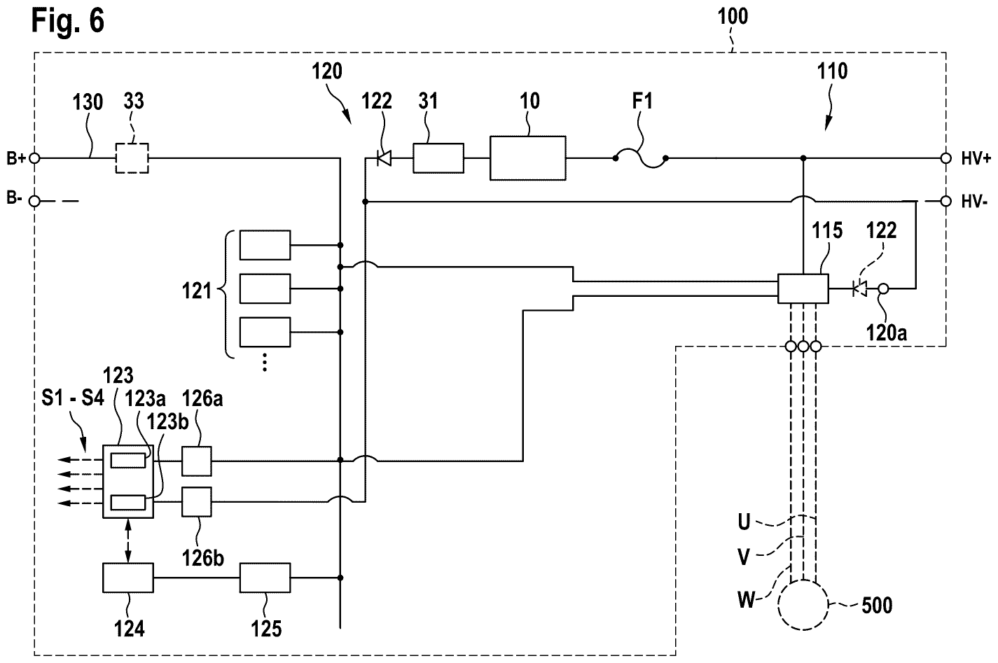

In FIGS. 1, 2 and 3, the first low-voltage branch 120 serves in the broadest sense to supply power to the components of the inverter. The first low-voltage branch 120 can also be referred to as PDN (see above). The second low-voltage branch 130 serves as a backup supply or safety power supply. FIG. 6 shows an embodiment of an inverter 100 which differs essentially from the embodiments of FIGS. 1, 2 and 3 in that the second low-voltage branch 130 serves to supply energy to the components of the inverter, and the first low-voltage branch 120 serves as a backup supply or safety power supply.

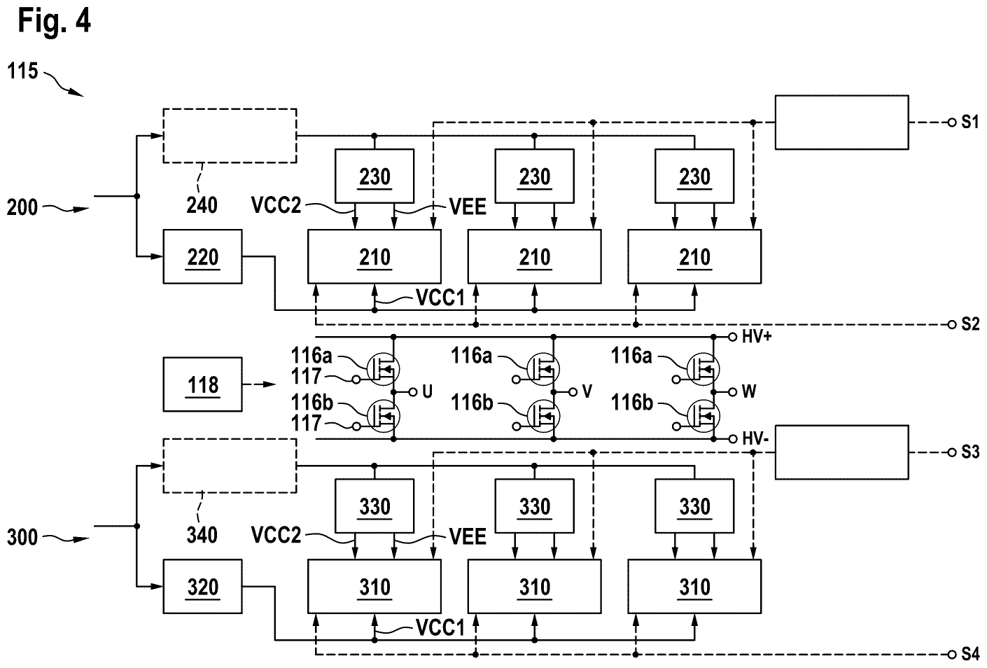

A power converter circuit 115 is used to connect the AC voltage terminals U, V, W (three in the example shown) of an electrical machine 500, which is not part of the inverter 100, to the positive DC voltage terminal HV+ and the negative DC voltage terminal HV− of the high-voltage branch 110. For this purpose, the power converter circuit 115 can comprise a logic circuit 118 (see FIGS. 4, 5, 7) for generating control signals and a number of semiconductor switches 116a, 116b to be controlled by means of the control signals.

The inverter 100 has a housing from which the terminals HV+, HV−, B+, B−, U, V, W and, in particular, communication (e.g. CAN, LIN, etc.) and/or sensor (e.g. speed, angular position, temperature, etc.) and/or other terminals are led out. The inverter 100 can advantageously be structurally connected to the electrical machine 500, i.e. in particular attached to it.

The power converter circuit 115 is shown schematically in FIGS. 4, 5, 7 and has so-called high-side, HS switches 116a (each between an AC voltage terminal U, V, W of the electrical machine 500 and the positive DC voltage terminal HV+) and so-called low-side, LS switches 116b (each between an AC voltage terminal U, V, W of the electrical machine 500 and the negative DC voltage terminal HV−).

For operation of the HS switches 116a, an HS power supply circuit 200 is provided in the present case, and for operation of the LS switches 116b, an LS power supply circuit 300 is provided in the present case. The elements of the HS power supply circuit 200 and the LS power supply circuit 300 are each provided with a reference sign increased by 100 and are described together in the following.

Each of the switches 116a, 116b has a control terminal 117 (e.g. gate terminal of a MOSFET or IGBT) to which a control signal is applied by a so-called gate driver circuit 210, 310 (hereinafter also referred to simply as gate driver) in order to switch the switch.

Modern isolated gate drivers generally require a low-voltage supply VCC1 for the primary side. This can usually be 5V or 3.3V and is generated from the low voltage via low dropout regulators (LDO) 220, 320, for example. Gate drivers with integrated LDO can also be used so that a separate LDO can be omitted in such cases.

To turn on and off power semiconductor switches such as SiC MOSFET and IGBT, each gate driver usually requires two different voltage levels on the secondary side (i.e. on the side connected to gate 117 of switches 116a, 116b): a positive level VCC2 (e.g. +20 V for SiC MOSFET) and a negative level VEE (e.g. −4 V for SiC MOSFET), but this is not limited to these two voltage levels.

In order to safely control the switches 116a, 116b under normal conditions and also during active short circuits, an isolated gate driver power supply, also referred to as an isolated bias supply, is used in FIG. 4. To increase the reliability of the system, three HS bias supply circuits 230 are used for the HS gate drivers 210 and three LS bias supply circuits 330 are used for the LS gate drivers 310.

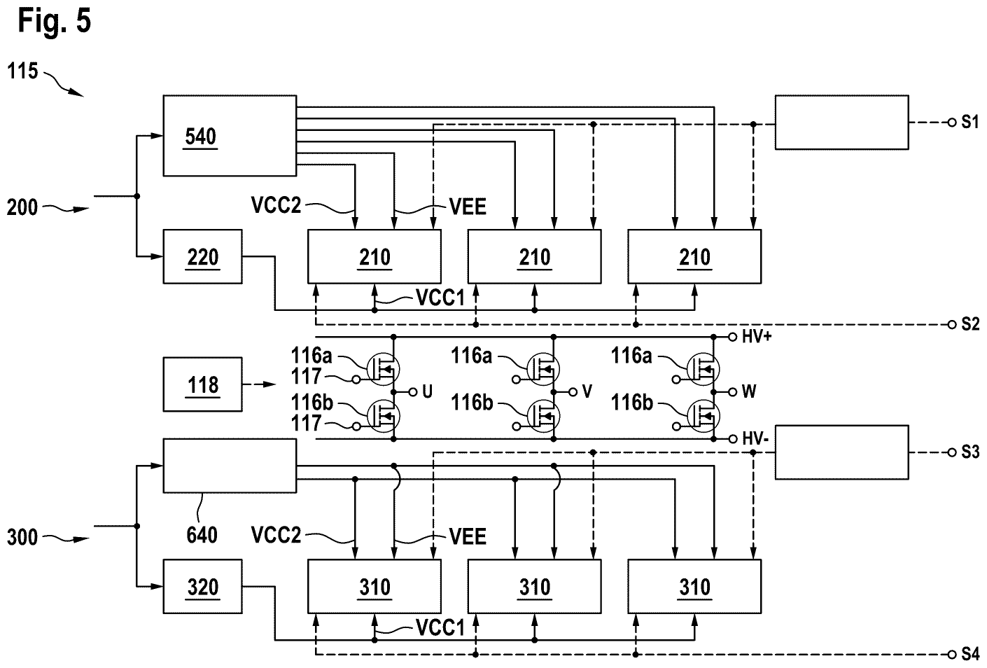

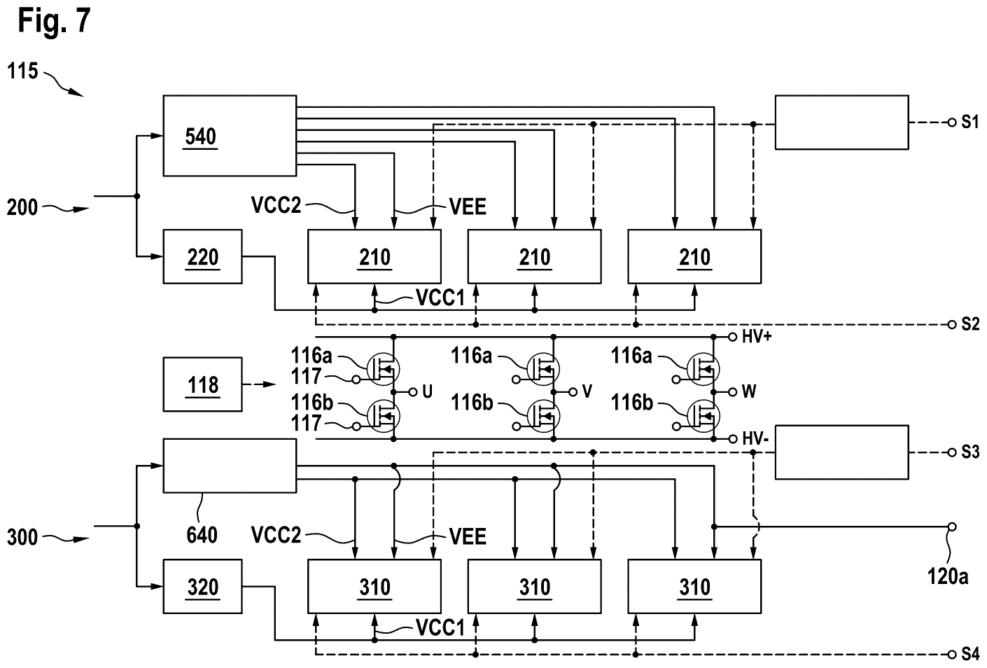

FIGS. 5 and 7 show another way of realizing the bias voltage supply, namely the use of a fly-back converter 540 with several windings as HS bias voltage supply circuit and the use of a further fly-back converter 640, also with several windings, as LS bias voltage supply circuit, which also results in isolated bias voltage supplies.

To realize a bias voltage supply, a voltage may be required that is above the nominal voltage level of the first low voltage branch 120 or second low voltage branch 130. If, in such a case, the bias supply circuits 230, 330 are not able to increase the voltage accordingly, pre-regulator power supply units 240, 340 can be used to supply the bias supply circuits 230, 330. In particular, these pre-regulator power supply units 240, 340 also comprise a DC-DC converter and convert the low voltage (e.g. 12 V or 15 V) to a higher voltage (e.g. 24 V). If the isolated bias supply circuits have the ability to increase the voltage sufficiently (e.g. with the help of a boost-blocking converter or SEPIC (single ended primary inductance converter)), then these pre-regulator power supply units 240, 340 are not required.

Since modern gate drivers can receive a safety request (e.g. for ASC) on both the primary and secondary side (the primary chip is isolated from the secondary chip of the gate driver), it can receive two (safe-state) signals S1, S2 or S3, S4; one (S2, S4) for the primary side and one (S1, S3) for the secondary side. These signals are shown with dashed lines.

Modern isolated gate drivers are capable of receiving two types of safety signals, an ASC enable signal (ASC_EN), which requests the safe state, and an ASC state signal (ASC_ST), which specifies the type of safe state. To reduce the complexity of the figures, only one signal S1 to S4 per side (primary, secondary) is shown. However, it should be noted that each of the signals S1 to S4 can internally comprise several types of safety signals.

In the first low-voltage branch 120 (FIGS. 1, 2, 3) or second low-voltage branch 130 (FIG. 6), one or more low-voltage consumers 121 of the inverter, only indicated schematically, are also arranged, e.g. sensors (e.g. speed, angular position, temperature, etc.), communication devices (CAN transceiver, LIN transceiver, etc.), etc.

Furthermore, a (functional) safety control device 123 is provided, i.e. a functional safety control device. The task of such a safety control device is, in particular, to monitor the inverter 100, to determine the state of the inverter and, if necessary, to aggregate the signals S1 to S4 for the safe state so that the power converter circuit can operate with normal drive control or can switch to a safe state such as ASC or the like. In order to realize this, it is advantageous if the safety control device 123 communicates with as many components or modules of the inverter 100 as possible and also with a higher-level control unit 124, such as a so-called MCU (motor control unit or microcontroller unit), in particular in order to achieve a desired “Automotive Safety Integrity Level” (ASIL) (depending on the functional safety objectives). The communication and signal transmission between the safety control device 123 and the higher-level control unit 124 is shown as a double arrow with a dashed line.

To increase safety, a power management circuit 125 for the power supply is provided for the higher-level control unit 124, for example in the form of a so-called PMIC (power management IC, integrated circuit) or safety PMIC or safety system base chip (safety SBC). A safety PMIC integrates several DC-DC converters in one housing. The component usually has built-in protective functions such as soft start, pulse current limiting, independent voltage monitoring, temperature measurement and shutdown in the event of excessive power loss. A PMIC usually has a watchdog timer to ensure the integrity of the microcontroller used in the system.

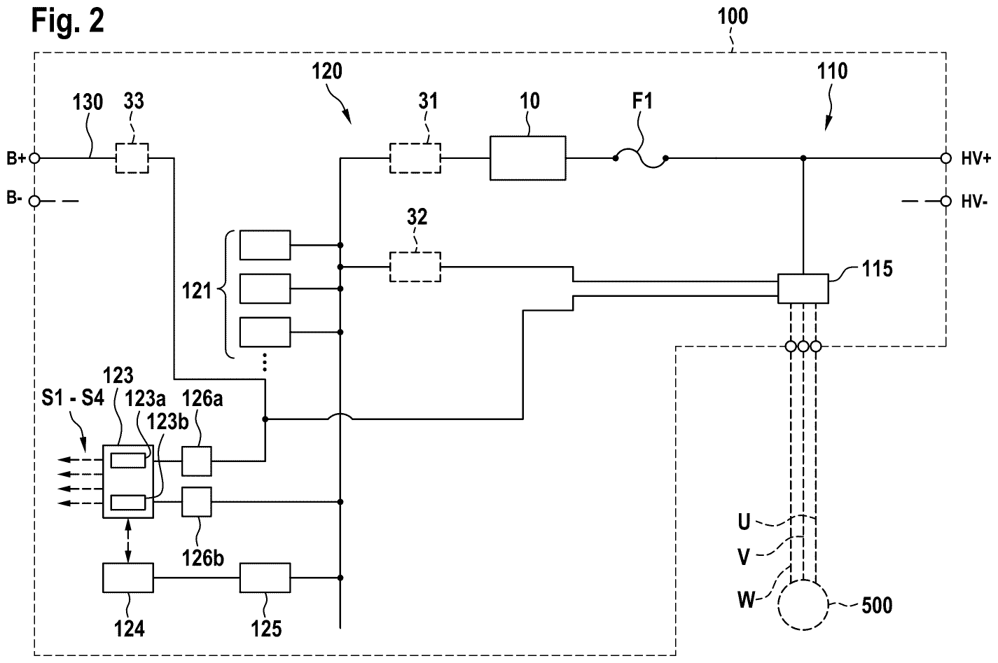

In FIG. 1, the safety control device 123 is supplied with power or energy by a power supply circuit 126. To increase safety, the safety control device 123 is also simultaneously supplied with power by the energy management circuit 125. In FIGS. 2, 3 and 6, the safety control device 123 is supplied with current or energy via a first power supply circuit 126a and via a second power supply circuit 126b.

In order to achieve the objective of functional safety (e.g. ASIL D), the safety control device 123 can have two separate safety logic circuits 123a, 123b, which have two independent power supply units. In FIG. 1, the first safety logic circuit 123a is supplied by the power supply circuit 126 and the second safety logic circuit 123b is supplied by the power management circuit 125. In FIGS. 2, 3 and 6, the first safety logic circuit 123a is supplied by the first power supply circuit 126a and the second safety logic circuit 123b is supplied by the second power supply circuit 126b. In the event of a power failure in one of the two safety logic circuits, the other safety logic circuit can ensure the transition to a safe state.

In order to achieve a desired level of functional safety, different measurement signals can be supplied to the safety control device 123 and the higher-level control unit 124, such as temperatures, speed, the voltage of various parts of the power converter circuit or the on-board power system, etc., fault or health states/signals of power supply units, sensors, gate drivers, main switches, etc.

In common inverters without two low-voltage branches 120, 130, faults (interruption or short circuit) can lead to an interruption of the power supply for the single low-voltage branch or to a latent fault and affect the safety control device 123 or the power supply units of the gate drivers in such a way that a transition to the safe state for the power converter circuit 115 is not possible. In order to counter such situations advantageously, additional precautions are taken in the inverter, which are described below.

As shown, the first low-voltage branch 120 is not electrically connected to the second low-voltage branch 130. In FIGS. 1 and 2, the second low-voltage branch 130 establishes its own connection to the LS power supply circuit 300 and also to the safety logic circuit 123a.

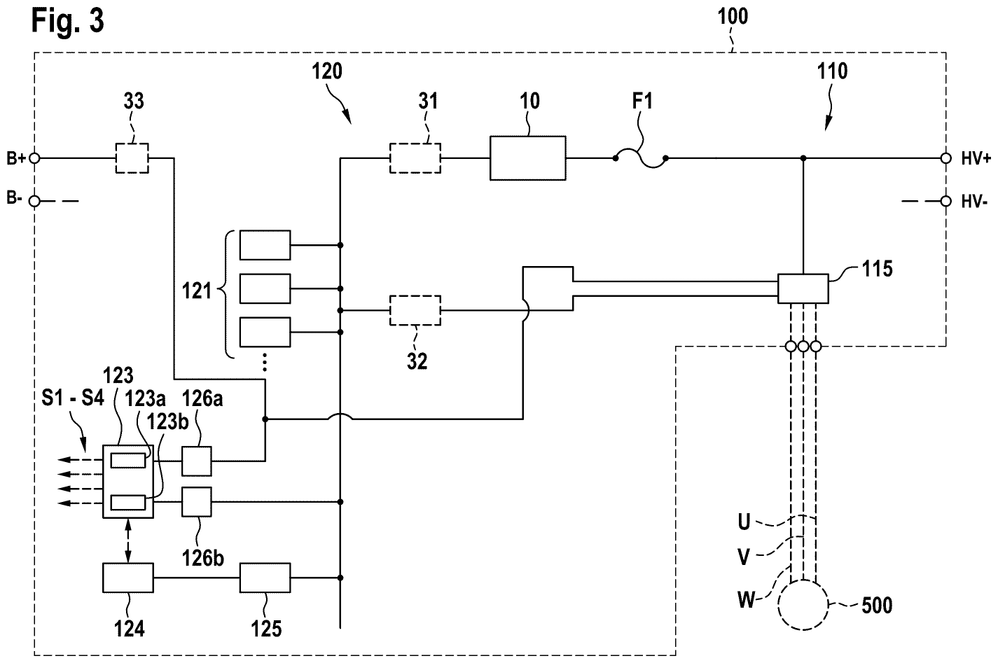

Alternatively, the second low-voltage branch 130 can also establish a connection to the HS power supply circuit 200 (FIG. 3) and to the safety logic circuit 123b (not shown).

FIGS. 1 and 2 show embodiments in which the at least one gate driver circuit 310 for the low-side semiconductor switches 116b is supplied or can be supplied with energy from the second low-voltage branch 130. FIG. 3 shows an embodiment in which at least the at least one gate driver circuit 210 for the HS semiconductor switches 116a is supplied or can be supplied with energy from the second low-voltage branch 130. FIGS. 6 and 7 show an embodiment in which at least the at least one gate driver circuit 310 for the LS semiconductor switches 116b is supplied or can be supplied with energy from the first low-voltage branch 120, for which a terminal 120a is provided. In order to ensure current isolation between the second low-voltage branch 130 and the first low-voltage branch 120 or the high-voltage branch 110, a current blocking circuit, such as a diode 122, is expediently provided. As shown in FIG. 6, the diode 122 can be arranged downstream of the operating DC-DC converter 10, if present also downstream of a safety disconnector 31, or in series with the terminal 120a.

In FIG. 1, the safety control device 123 is connected to the second low-voltage branch 130 via the power supply circuit 126, and is connected to the first low-voltage branch 120 via the energy management circuit 125. In FIGS. 2 and 3, the safety control device 123 is connected to the second low-voltage branch 130 via a first power supply circuit 126a, and is connected to the first low-voltage branch 120 via a second power supply circuit 126b. In FIG. 6, the safety control device 123 is connected to the second low-voltage branch 130 via the first power supply circuit 126a, and is connected to the first low-voltage branch 120 via the second power supply circuit 126b.

As long as at least one of the two low-voltage branches 120, 130 is supplied, the safety control device 123 is supplied from one or both low-voltage branches. If the supply from one of the two low-voltage branches fails, the safety control device 123 or its first or second safety logic circuit 123a, 123b is supplied from the other low-voltage branch. The remaining safety logic circuit can initiate the safe state for a gate driver.

In embodiments, one or more (optional) safety disconnectors 31 to 33 are added to the inverter in order to protect the power supply as a whole and to be able to isolate faulty areas from the rest of the network. The safety disconnectors 31 to 33 prevent a fault from propagating through the inverter and also latent faults. The safety disconnectors 31 to 33 can communicate with the safety control device 123 and higher-level control unit 124 (communication links not shown).

The safety control device 123 is configured to bring the power converter circuit 115 into a safe state if a shutdown situation is present, the presence of a shutdown situation being detected in particular if at least one of the safety disconnectors 31 to 33 is in an open state.

A first safety disconnector 31 may be added in series with the operating DC-DC converter 10. When a fault occurs in the operating DC-DC converter 10, the first safety disconnector 31 may open, thereby protecting the first low-voltage branch 120 and interrupting the fault current, as well as informing the safety control device 123 and/or the higher-level control unit 124 of the fault (if necessary). The LS power supply circuit 300 and safety control device 123 can then be supplied from the second low-voltage branch 130.

A second safety disconnector 32 may be added in series with the HS power supply circuit 200 (see FIGS. 1, 2) or the LS power supply circuit 300 (see FIG. 3) as the first power supply circuit supplied from the first low-voltage branch 120. If a fault occurs in the first power supply circuit 200, the second safety disconnector 32 can open and thereby protect the first low-voltage branch 120 from fault propagation and interrupt the fault current, as well as inform the safety control device 123 and/or the higher-level control unit 124 of the fault (if necessary).

A third safety disconnector 33 may be added in series with the second low-voltage branch 130. If a fault occurs in the low-voltage network B+, the third safety disconnector 33 can open and thereby protect the second low-voltage branch 130 and interrupt the fault current, as well as inform the safety control device 123 and/or the higher-level control unit 124 of the fault (if necessary). Power supply can then be provided from the high-voltage branch 110 via the first low-voltage branch 120.

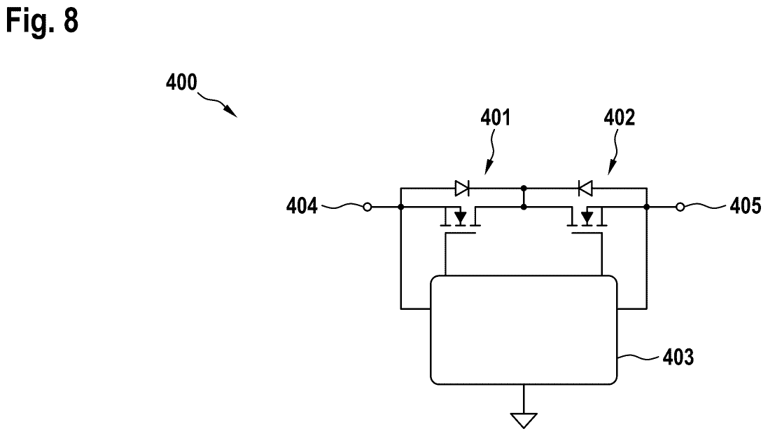

All these safety disconnectors 31 to 33 can be designed as diagnostic and monitoring modules with an integrated control circuit and protect against short circuit, ground fault, reverse current blocking, overvoltage and also undervoltage. An example of a simplified safety disconnector 400 is shown in FIG. 8. In general, a safety disconnector 400 can be implemented using electronic switches 401, 402 such as MOSFETs and a control circuit 403 that receives signals, particularly with respect to current and/or voltage, from input 404 and output 405 and controls the gate of the MOSFETs. The control circuit 403 is alternatively or additionally configured to open or close the electronic switches 401, 402 in accordance with a control signal, in particular from the safety control device 123 or the higher-level control unit 124.

To protect the primary and secondary sides of the operating DC-DC converter 10, a fuse F1 is provided as a high-voltage disconnector so that in the event of a fault on the primary side, e.g. a short circuit in a transformer winding of an electrically isolated DC-DC converter or a short-circuited switch, the fuse isolates the faulty section.

In the inverter as shown in FIG. 3, the HS power supply circuit 200 is supplied from the second low-voltage branch 130. The first safety logic circuit 123a is also supplied from the second low-voltage branch 130 as before.

In all the variants shown, faults in the first low-voltage branch 120 and in the second low-voltage branch 130 are isolated from each other. This means that the fault cannot be passed on from the first low-voltage branch 120 to the second low-voltage branch 130 and vice versa.

If a fault occurs in the first low-voltage branch 120 or in the high-voltage branch 110, the second low-voltage branch 130 can guarantee the supply of the first safety logic circuit 123a and the respective LS or HS power supply circuit 200, 300 (only one of them). The execution of the safe state is therefore guaranteed.

The disclosure can increase functional safety and reliability without the need to prove complete redundancy for the inverter of an inverter, which would increase costs by a factor of 2. Advantageously, the second low-voltage branch also does not have to be strong enough to supply the entire inverter, which leads to a reduction in costs when implementing this concept.

What is claimed is:

1. An inverter (100) for driving an electric machine (500),
the inverter (100) having a power converter circuit (115), a safety control device (123) and a power supply circuit for supplying the power converter circuit (115) and the safety control device (123),
wherein the safety control device (123) is configured to switch the power converter circuit (115) to a safe state when a shutdown situation is present,
wherein the power supply circuit has a high-voltage branch (110), a first low-voltage branch (120) and a second low-voltage branch (130),
wherein the high-voltage branch (110) is electrically connected to the first low-voltage branch (120) via an operating DC-DC converter (10),
wherein neither the high-voltage branch (110) nor the first low-voltage branch (120) is electrically connected to the second low-voltage branch (130),
wherein the power converter circuit (115) and the safety control device (123) are supplied with energy from the first low-voltage branch (120) and the second low-voltage branch (130).

2. The inverter (100) according to claim 1,
wherein the safety control device (123) comprises at least two power supply circuits (125, 126; 126a, 126b), a first one of the at least two power supply circuits being energized from the first low-voltage branch (120) and a second one of the at least two power supply circuits (130) being energized from the second low-voltage branch (130).

3. The inverter (100) according to claim 1,
wherein the power converter circuit (115) comprises at least two power supply circuits (200, 300), a first power supply circuit of the at least two power supply circuits being energized from the first low-voltage branch (120) and a second power supply circuit of the at least two power supply circuits being energized from the second low-voltage branch (130).

4. The inverter (100) according to claim 3,
wherein the first power supply circuit of the at least two power supply circuits can be disconnected from the first low-voltage branch (120) by means of a second safety disconnector (32).

5. The inverter (100) according to claim 4,
wherein the second safety disconnector (32) comprises at least one electronic switch (401, 402) between an input (404) and an output (405) and a control circuit (403), wherein the control circuit (403) is configured to open or close the at least one electronic switch (401, 402) in accordance with a control signal.

6. The inverter (100) according to claim 4,
wherein the safety control device (123) is configured to detect the presence of a shutdown situation when second safety disconnector (32) is in a non-conductive state.

7. The inverter (100) according to claim 3,
wherein the at least two power supply circuits (200, 300) of the power converter circuit (115) each have a gate driver circuit (210, 310), wherein a first gate driver circuit (210) is supplied with power from the first low-voltage branch (120) and a second gate driver circuit (310) is supplied with power from the second low-voltage branch (130).

8. The inverter (100) according to claim 7,
wherein the at least two power supply circuits (200, 300) of the power converter circuit (115) each comprise a bias voltage supply circuit (230, 330; 540, 640) for the gate driver circuit (210, 310), wherein a first bias voltage supply circuit (230) is powered from the first low voltage branch (120) and a second bias voltage supply circuit (330) is powered from the second low voltage branch (130).

9. The inverter (100) according to claim 1,
wherein the operating DC-DC converter (10) can be disconnected from the first low-voltage branch (120) by means of a first safety disconnector (31).

10. The inverter (100) according to claim 9,
wherein the first safety disconnector (31) comprises at least one electronic switch (401, 402) between an input (404) and an output (405) and a control circuit (403), wherein the control circuit (403) is configured to open or close the at least one electronic switch (401, 402) in accordance with a control signal.

11. The inverter (100) according to claim 9,
wherein the safety control device (123) is configured to detect the presence of a shutdown situation when first safety disconnector (31) is in a non-conductive state.

12. The inverter (100) according to claim 1,
wherein the operating DC-DC converter (10) can be disconnected from the high-voltage branch (110) by means of a high-voltage disconnector (F1).

13. The inverter (100) according to claim 1,
wherein the second low-voltage branch (130) can be disconnected from an external power supply (B+) by means of a third safety disconnector (33).

14. The inverter (100) according to claim 13,
wherein the third safety disconnector (33) comprises at least one electronic switch (401, 402) between an input (404) and an output (405) and a control circuit (403), wherein the control circuit (403) is configured to open or close the at least one electronic switch (401, 402) in accordance with a control signal.

15. The inverter (100) according to claim 13,
wherein the safety control device (123) is configured to detect the presence of a shutdown situation when the third safety disconnector (33) is in a non-conductive state.

16. The Inverter (100) according to claim 1, wherein
the safety control device (123) comprises at least two safety logic circuits (123a, 123b), wherein a first (123a) of the at least two safety logic circuits is supplied or can be supplied with energy from the first low-voltage branch (120) and a second (123b) of the at least two safety logic circuits is supplied or can be supplied with energy from the second low-voltage branch (130).

17. A method of operating the inverter (100) according to claim 1, comprising:
in the presence of a shutdown situation, bringing the power converter circuit (115) into a safe state.

18. The method according to claim 17,
wherein the operating DC-DC converter (10) can be disconnected from the first low-voltage branch (120) by means of a first safety disconnector (31),
the method comprising:
detecting that a shutdown situation is present when the first safety disconnector (31) detects a fault, and/or when the first safety disconnector (31) is in an open state.

19. The method according to claim 17,
wherein the power converter circuit (115) comprises at least two power supply circuits (200, 300), a first power supply circuit of the at least two power supply circuits being energized from the first low-voltage branch (120) and a second power supply circuit of the at least two power supply circuits being energized from the second low-voltage branch (130),
wherein the first power supply circuit of the at least two power supply circuits can be disconnected from the first low-voltage branch (120) by means of a second safety disconnector (32),
the method comprising:
detecting that a shutdown situation is present when the second safety disconnector (32) detects a fault, and/or when the second safety disconnector (32) is in an open state.

20. The method according to claim 17,
wherein the second low-voltage branch (130) can be disconnected from an external power supply (B+) by means of a third safety disconnector (33),
the method comprising:
detecting that a shutdown situation is present when the third safety disconnector (33) detects a fault, and/or when the third safety disconnector (33) is in an open state.

21. The method according to claim 17, comprising:
detecting that a shutdown situation is present when a fault occurs in the operating DC-DC converter (10).

22. The method according to claim 17, comprising:
detecting that a shutdown situation is present when a gate driver circuit (210; 310) detects a fault, in particular in the power supply from the first low-voltage branch (120) and/or the second low-voltage branch (130).
